(19) United States
(12) Patent Application Publication
(10) Pub. No.: US 2009/0322938 A1
(43) Pub. Date: Dec. 31, 2009

(54) METHOD AND RELATED IMAGE PROCESSING APPARATUS UTILIZED FOR COMBINING COLOR LOOK-UP TABLE AND VIDEO DAC CALIBRATION MAPPING TABLE

(76) Inventors: Yang-Hung Shih, Hsinchu City (TW); Tang-Hung Po, Pingtung County (TW); Tsung-Kai Kao, Taipei City (TW); Shang-Yi Lin, Hsinchu County (TW)

Correspondence Address: NORTH AMERICA INTELLECTUAL PROPERTY CORPORATION, P.O. BOX 506, MERRIFIELD, VA, 22116, US

(21) Appl. No.: 12/147,485

(22) Filed: Jun. 27, 2008

(51) Int. Cl. H04N 7/01

(52) U.S. Cl. 348/441; 348/E09.037

(57) ABSTRACT

A signal processing apparatus for generating an output analog signal according to a raw digital signal is disclosed. The signal processing apparatus includes a DAC, a storage device, and an adjusting device. The storage device is utilized for storing a target mapping table equivalent to a combination of a predetermined correction mapping table and a DAC calibration mapping table corresponding to the DAC. The adjusting device is coupled to the DAC and the storage device, and is utilized for adjusting the raw digital signal to generate a calibrated digital signal according to the target mapping table stored in the storage device. The DAC converts the calibrated digital signal to generate the output analog signal.

### BACKGROUND

The present invention relates to a signal processing scheme, and more particularly, to a method and related image processing apparatus for building a target mapping table by combining a color look-up table and a DAC calibration mapping table, and to an image processing apparatus for storing a target mapping table equivalent to a combination of the color look-up table and the DAC calibration mapping table.

Generally speaking, with the continued development of IC (integrated circuit) process technology, in a field of deep sub-micro IC technology, linearity of a DAC design becomes very poor when a supply voltage is decreased. For instance, the supply voltage may be decreased from 1.55 Volts (or 1.2 Volts) to 1 Volts in the 90-Nano process technology. This nonlinear problem will become more and more serious with the developments of advanced IC process technologies.

### SUMMARY

Therefore one of the objectives of the present invention is to provide a method and related image processing apparatus for building a target mapping table by combining a color look-up table and a DAC calibration mapping table, and an image processing apparatus for storing a target mapping table equivalent to a combination of the color look-up table and the DAC calibration mapping table, to solve the problem caused by nonlinearity of a video DAC. Additionally, another objective of the present invention is to provide a signal processing apparatus for storing a target mapping table equivalent to a combination of a predetermined correction mapping table and another DAC calibration mapping table and utilizing the target mapping table to adjust a raw digital signal, to solve problems caused by nonlinearity of a DAC.

According to an embodiment of the present invention, a method for building a target mapping table utilized for converting a raw digital image signal into a calibrated digital image signal is disclosed. The method comprises: storing a color look-up table; calculating a digital-to-analog converter (DAC) calibration mapping table; and combining the color look-up table and the DAC calibration mapping table to generate the target mapping table.

According to an embodiment of the present invention, an image processing apparatus is disclosed. The image processing apparatus comprises a storage device and an adjusting device. The storage device is utilized for storing a color look-up table. The adjusting device is coupled to the storage device and utilized for calculating a DAC calibration mapping table, for combining the color look-up table and the DAC calibration mapping table to generate a target mapping table used for converting a raw digital image signal into a calibrated digital image signal, and for storing the target mapping table into the storage device.

According to an embodiment of the present invention, an image processing apparatus for outputting an output analog image signal according to a raw digital image signal is disclosed. The image processing apparatus comprises a video DAC, a storage device, and an adjusting device. The storage device is utilized for storing a target mapping table equivalent to a combination of a color look-up table and a DAC calibration mapping table corresponding to the video DAC. The adjusting device is coupled to the video DAC and the storage device, and is utilized for adjusting the raw digital image signal to generate a calibrated digital image signal according to the target mapping table stored in the storage device. The DAC is utilized for converting the calibrated digital image signal to generate the output analog image signal.

According to an embodiment of the present invention, a signal processing apparatus for generating an output analog signal according to a raw digital signal is disclosed. The signal processing apparatus comprises a DAC, a storage device, and an adjusting device. The storage device is utilized for storing a target mapping table equivalent to a combination of a predetermined look-up table and a DAC calibration mapping table corresponding to the DAC. The adjusting device is coupled to the DAC and the storage device, and is utilized for adjusting the raw digital signal to generate a calibrated digital signal according to the target mapping table stored in the storage device. The DAC is utilized for converting the calibrated digital signal to generate the output analog signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a simplified diagram of a TV system according to an embodiment of the present invention.

FIG. 2 is a simplified diagram of a TV processor shown in FIG. 1 according to a first embodiment of the present invention.

FIG. 3 is a diagram showing an example of combining a gamma correction mapping table and a DAC calibration mapping table to generate a target mapping table according to the first embodiment of the present invention.

FIG. 4 is a flowchart illustrating the operation of the adjusting device by referring to the target mapping table of FIG. 3 to obtain the calibrated digital image signal.

FIG. 5 is a diagram showing a process of establishing the DAC calibration mapping table of FIG. 3.

FIG. 6 is a diagram showing an example of a practical conversion curve sketched by the receiving unit of FIG. 5

FIG. 7 is a diagram showing an example of building the DAC calibration mapping table according to a practical conversion curve and an ideal conversion curve.

FIG. 8 is a flowchart showing the process of establishing the DAC calibration mapping table shown in FIG. 3.

FIG. 9 is a simplified diagram of an image processing apparatus according to a second embodiment of the present invention.

FIG. 10 is a simplified diagram of an image processing apparatus according to a third embodiment of the present invention.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

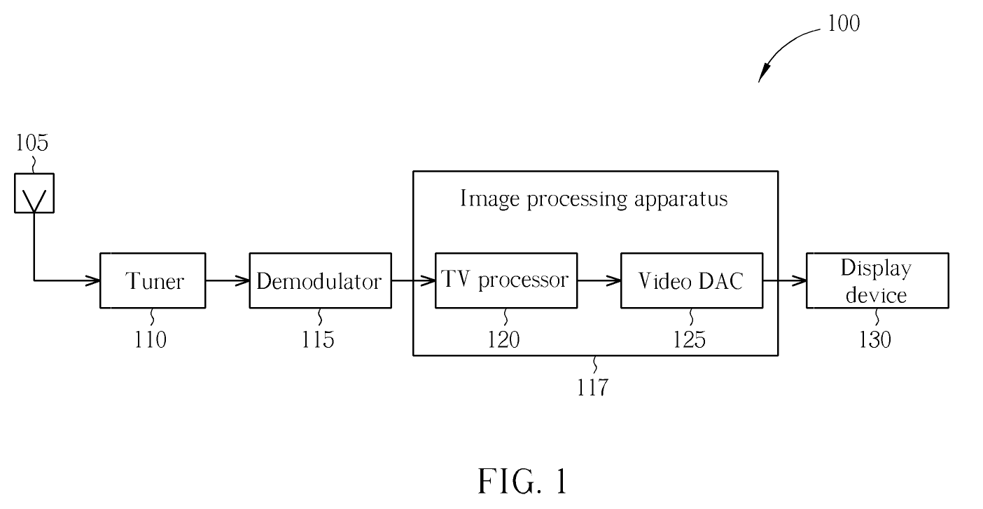

In the following description, although the disclosed embodiments of the present invention relate to the field of video processing, the spirit of the present invention should not be limited by the field of video processing since apparatus and related methods provided in the disclosed embodiments for solving problems caused by the nonlinearity of a video DAC can also be applied to solving problems caused by the nonlinearity of a DAC in another field (e.g. in the field of audio processing). Please refer to FIG. 1. FIG. 1 is a simplified diagram of a television (TV) system 100 according to an embodiment of the present invention. As shown in FIG. 1, the TV system 100 comprises an antenna 105, a tuner 110, a demodulator 115, an image processing apparatus 117 having a TV processor 120 and a video DAC 125, and a display device 130. The antenna 105 is utilized for receiving a radio frequency (RF) signal and for outputting the RF signal to the tuner 110 that amplifies and then down-converts the received RF signal to generate an intermediate frequency (IF) signal or a low frequency signal. An objective of the tuner 110 is to select a desired program/channel for viewers from multiple programs or channels broadcasted by the RF signal. The demodulator 115 is utilized for demodulating the intermediate/low frequency signal to output a baseband signal to the TV processor 120. The TV processor 120 is utilized for processing a video stream and an audio stream in the baseband signal to output a digital image signal to the video DAC 125, which converts the digital image signal into an output analog image signal Sₐ and transmits the output analog image signal Sₐ to the display device 130 that can be a display monitor, a TV set, or a video recorder. Thus a viewer can watch the desired program/channel on the display device 130 (e.g. on a display monitor) or record the desired program/channel in the display device 130 (e.g. in a video recorder).

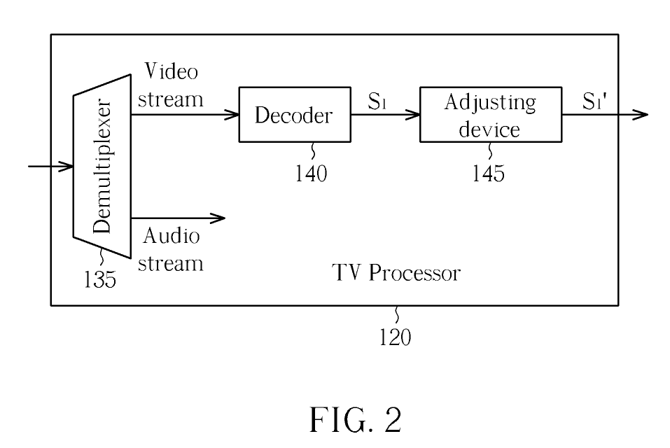

Please refer to FIG. 2. FIG. 2 is a simplified diagram of the TV processor 120 shown in FIG. 1 according to a first embodiment of the present invention. The TV processor 120 comprises a demultiplexer 135, a decoder 140, and an adjusting device 145. Please note that, since the description relates to video processing, a description of how to process the audio stream is not detailed here and related elements for processing the audio stream are also not shown in FIG. 2 for brevity. The demultiplexer 135 is utilized for separating the baseband signal outputted from the demodulator 115 into the above-mentioned video and audio streams, and the decoder 140 is utilized for decoding the video stream to generate a raw digital image signal S₁ (e.g. a raw pixel color value). The raw digital image signal S₁ is then processed by the adjusting device 145 coupled to the video DAC 125 and a storage device (the storage device (e.g. a memory) is not shown in FIG. 2). The adjusting device 145 (usually a processor and a firmware) is utilized for performing a gamma correction and a DAC calibration on the raw digital image signal S₁ to generate a calibrated digital image signal S₁′ to the video DAC 125 such that viewers can easily discriminate between gradation levels of contrast of an image on the display device 130, and also ensures that the gradations of contrast of the image are not affected by the nonlinearity of the video DAC 125. The reason for utilizing the gamma correction is that different manufacturers may request the display device 130 to be able to express different gradation levels of contrast of the image. For adjusting the raw digital image signal S₁, a color look-up table (commonly referred to as a gamma correction mapping table) corresponding to a transfer curve of the gamma correction and a DAC calibration mapping table for solving the problem caused by the nonlinearity of the video DAC 125 are therefore necessary. Usually, the gamma correction mapping table can be obtained from manufacturers producing display devices, however, the process of how to calculate the DAC calibration mapping table will also be detailed as follows. In this embodiment, the gamma correction mapping table and DAC calibration mapping table are combined in advance to generate a target mapping table, which is stored in the storage device. It is not required for the storage device to store the gamma correction mapping table and DAC calibration mapping table simultaneously. An advantage is that a part of storage areas of the storage device can be saved. Moreover, if the storage device is only utilized for storing information used for performing the gamma correction and DAC calibration (i.e. the target mapping table), a size of the storage device can be substantially equal to a maximum between sizes of the gamma correction mapping table and DAC calibration mapping table. It should be noted that the TV processor 120 is usually a TV processing IC (integrated circuit) and the above-mentioned storage device can be disposed within the TV processing IC or outside the TV processing IC.

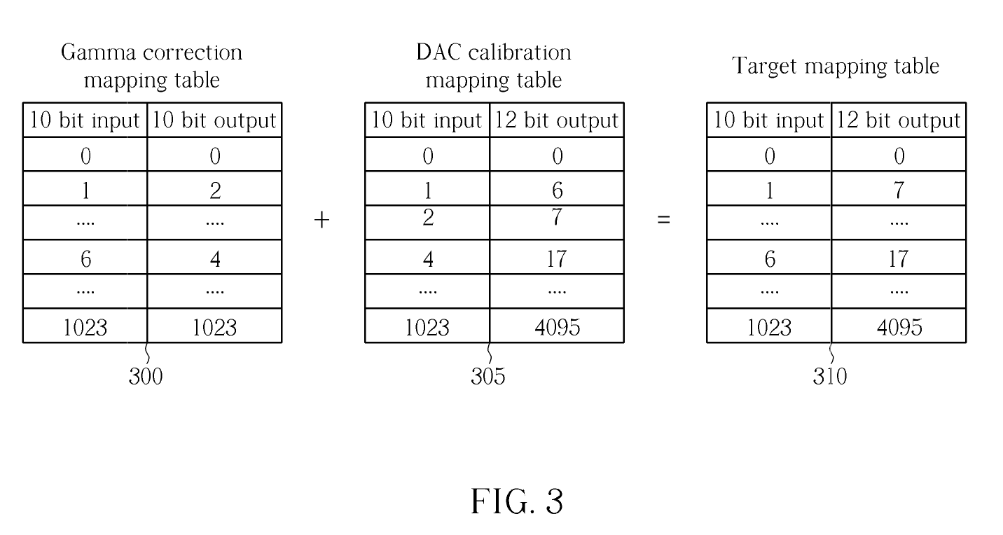

Please refer to FIG. 3. FIG. 3 is a diagram showing an example of combining a gamma correction mapping table 300 and a DAC calibration mapping table 305 to generate a target mapping table 310 according to the first embodiment of the present invention. As shown in FIG. 3, the gamma correction mapping table 300 includes a plurality of entries where each of the entries maps an input value to an output value (e.g. an input value ‘1’ is mapped to an output value ‘2’). The DAC calibration mapping table 305 also includes a plurality of entries where each of the entries maps an input value to an output value (e.g. an input value ‘2’ is mapped to an output value ‘7’). Accordingly, by combining the gamma correction mapping table 300 and DAC calibration mapping table 305, if a specific entry in the gamma correction mapping table 300 maps an input value (e.g. ‘1’) to an output value (e.g. ‘2’) and a specific entry in the DAC calibration mapping table 305 maps an input value (e.g. ‘2’) to an output value (e.g. ‘7’) where the input value in the gamma correction mapping table 300 is equal to the output value in the DAC calibration mapping table 305 (i.e. ‘2’), it will be recorded in an entry of the target mapping table 310 that an input value (i.e. ‘1’) is mapped to an output value (i.e. ‘7’). It should be noted that, for the adjusting device 145 in this embodiment, the gamma correction is performed before the DAC calibration. Additionally, to greatly improve the problems caused by the nonlinearity of the video DAC 125, an output value of each entry in the DAC calibration mapping table 305 has a 12-bit length longer than a bit length (10-bit) of an input value of this entry in the DAC calibration mapping table 305. Therefore, the calibrated digital image signal S₁′ outputted from the adjusting device 145 will have a higher bit resolution. Of course, other modifications altering (i.e. increasing) a bit length of an input/output value of an entry in the gamma correction mapping table 300 or the DAC calibration mapping table 305 can also be utilized for solving the problems due to the nonlinearity of the video DAC 125. This also falls within the scope of the present invention.

In another embodiment, however, the DAC calibration can be performed before the gamma correction. For instance, it is possible that a bit length of an output value of each entry in the DAC calibration mapping table 305 can be modified as a bit length equal to that of an input value of each entry in the gamma correction mapping table 300. If a first entry in a modified DAC calibration mapping table maps a first input value to a first output value, and a second entry in the gamma correction mapping table maps a second input value to a second output value where the second input value is equal to the first output value, it is recorded that an entry of a target mapping table maps the first input value to the second output value. The new target mapping table can also be applied to adjusting the raw digital image signal S₁ to generate the calibrated digital image signal S₁′, for solving the problems caused by the nonlinearity of the video DAC 125 and for simultaneously saving a part of storage areas of the storage device.

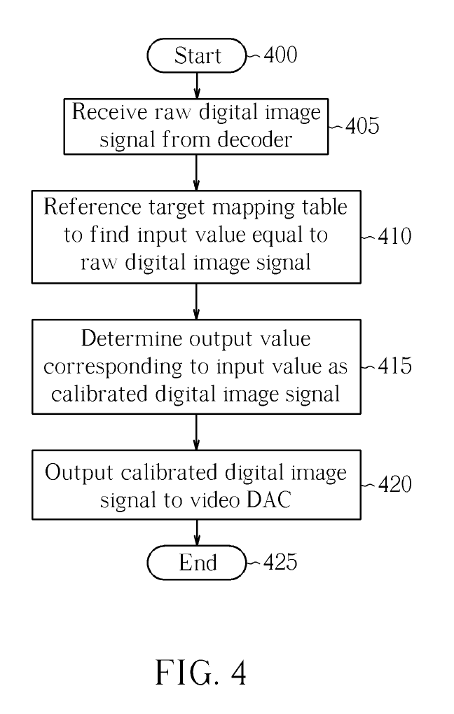

Please refer to FIG. 4. FIG. 4 is a flowchart illustrating the operation of the adjusting device 145 by referring to the target mapping table 310 of FIG. 3 to obtain the calibrated digital image signal S₁′. The operation of the adjusting device 145 is illustrated as follows:
Step 400: Start.
Step 405: Receive the raw digital image signal S₁ (e.g. a raw pixel color value) from the decoder 140.
Step 410: Reference the target mapping table 310 to find an input value equal to the raw digital image signal S₁.
Step 415: Determine an output value corresponding to the input value as the calibrated digital image signal S₁′ (e.g. a calibrated pixel color value).
Step 420: Output the calibrated digital image signal S₁′ to the video DAC 125.
Step 425: End.

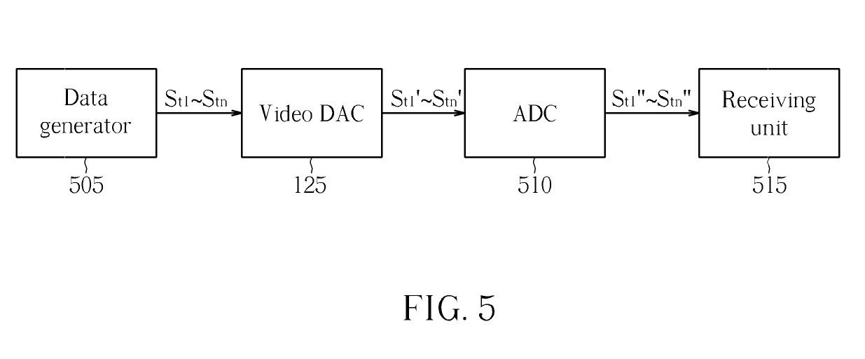

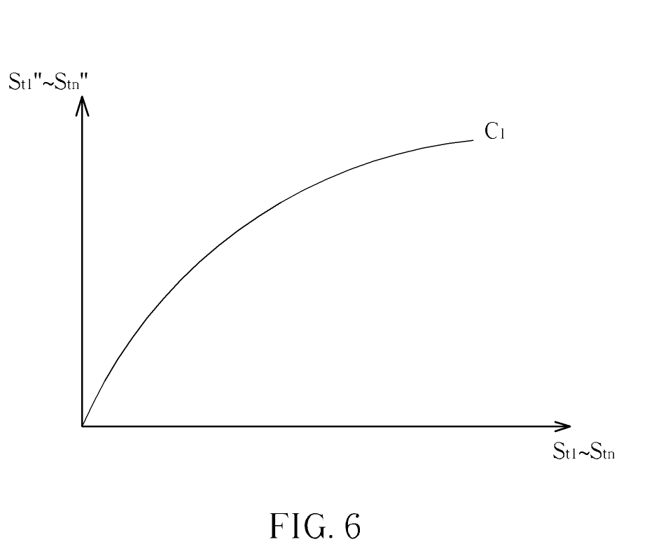

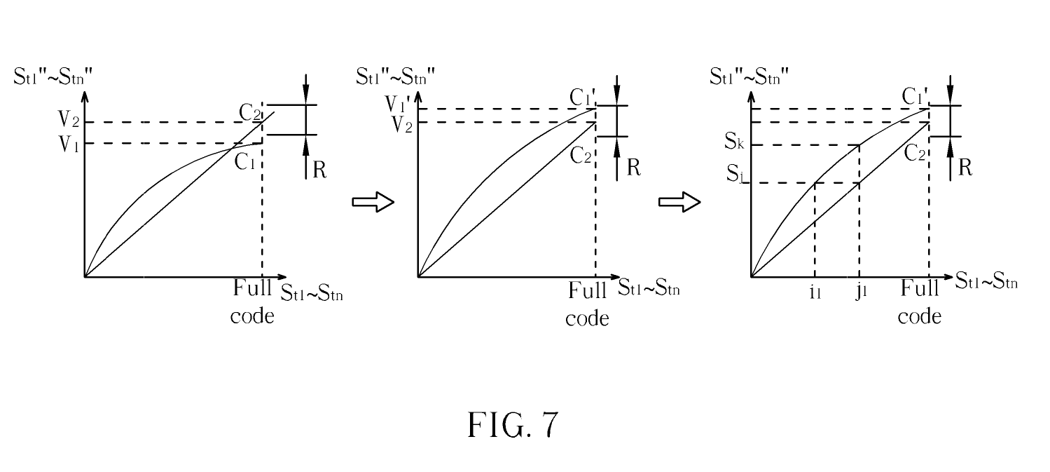

In this embodiment, the DAC calibration mapping table 305 is established in advance by inputting multiple digital test signals into the video DAC 125 and utilizing a precise analog-to-digital converter (i.e. a linear ADC). Please refer to FIG. 5. FIG. 5 is a diagram showing a process of establishing the DAC calibration mapping table 305 of FIG. 3. As shown in FIG. 5, a data generator 505 is utilized for generating multiple digital test signals Sₜ₁˜Sₜₙ and for outputting the digital test signals Sₜ₁˜Sₜₙ to the video DAC 125. Taking an example of each digital test signal having a 10-bit length, the digital test signals Sₜ₁˜Sₜₙ includes digital codes ‘0000000000’˜‘1111111111’ representative of values 0˜1023 respectively. The video DAC 125 then converts the digital test signals Sₜ₁˜Sₜₙ into multiple analog test signals Sₜ′˜Sₜₙ′. A linear ADC 510 is utilized for converting the analog test signals Sₜ₁′˜Sₜₙ′ into digital signals Sₜ₁″˜Sₜₙ″. In the example shown in FIG. 3, the digital signals Sₜ₁″˜Sₜₙ″ generated by the ADC 510 have identical 12-bit lengths. That is, the digital signals Sₜ₁″˜Sₜₙ″ are digital codes having 12-bit lengths. The digital signals Sₜ₁″˜Sₜₙ″ are then received by a receiving unit 515 and the receiving unit 515 draws a practical conversion curve according to the received digital signals Sₜ₁″˜Sₜₙ″ and the digital test signals Sₜ₁˜Sₜₙ. Please refer to FIG. 6. FIG. 6 is a diagram showing an example of a practical conversion curve C₁ sketched by the receiving unit 515 of FIG. 5. Please refer to FIG. 7. FIG. 7 is a diagram showing an example of building the DAC calibration mapping table 305 according to a practical conversion curve C₁ and an ideal conversion curve C₂. As shown in FIG. 7, in this example, it is assumed that a maximum value V₁ in the digital signals Sₜ₁″˜Sₜₙ″ outputted by the ADC 510 corresponds to a full code ‘1111111111’ in the digital test signals Sₜ₁˜Sₜₙ inputted into the video DAC 125. If the value V₁ does not fall within a predetermined range R of a maximum value V₂ of the ideal conversion curve C₂ corresponding to the full code ‘1111111111’ (as shown in a left chart of FIG. 7), the practical conversion curve C₁ will be adjusted to make the value V₁ fall within the predetermined range R of the value V₂ (as shown in a center chart of FIG. 7). For instance, the predetermined range R of the value V₂ can be designed as a range 0.9*V₂˜1.1*V₂. After the practical conversion curve is adjusted (in this example the practical conversion curve is boosted), the DAC calibration mapping table 305 is established by referring to the adjusted practical conversion curve C₁′ and the ideal conversion curve C₂ shown in the center chart of FIG. 7. For example, in a right chart of FIG. 7, if a digital signal (or a code) j₁ is directly transmitted into the video DAC 125, then an analog signal corresponding to a digital signal Sₖ will be outputted from the video DAC 125 into the display device 130 due to the nonlinearity of the video DAC 125. However, another analog signal corresponding to a digital signal Sⱼ should ideally be generated. Accordingly, the DAC calibration mapping table 305 is utilized for first converting the digital signal j₁ into another digital signal i₁ before the digital signal j₁ is outputted into the video DAC 125. The digital signal i₁ is then transmitted into the video DAC 125 and thus the desired analog signal corresponding to the digital signal Sⱼ can be outputted from the video DAC 125 even though the conversion performed by the video DAC 125 is not a linear operation. In this example, an input value and a corresponding output value of an entry in the DAC calibration mapping table 305 are therefore recorded as j₁ and i₁ respectively. If the input value j₁ has a 10-bit length, it can be a value representative of any code ‘0000000000’˜‘1111111111’. It should be noted that the practical conversion curve C₁ shown in FIG. 7 is an example for illustrative purposes only and this is not a limitation of the present invention.

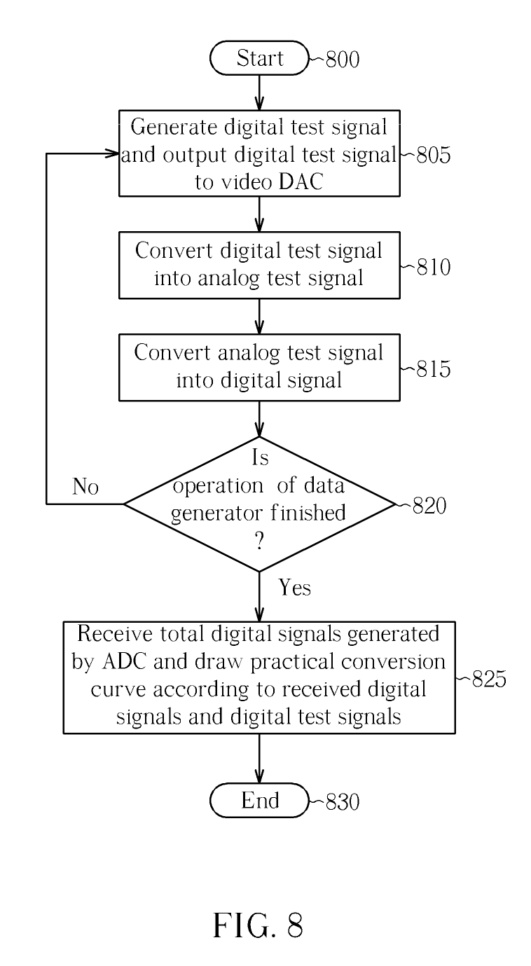

For a clear description of how to build the DAC calibration mapping table, the establishment of the DAC calibration mapping table 305 can be illustrated by the following flowchart. Please refer to FIG. 8. FIG. 8 is a flowchart showing the process of establishing the DAC calibration mapping table 305 shown in FIG. 3. The description is illustrated as follows:
Step 800: Start.
Step 805: The data generator 505 generates a digital test signal and outputs the digital test signal to the video DAC 125.
Step 810: The video DAC 125 converts the digital test signal into an analog test signal.
Step 815: The ADC 510 converts the analog test signal into a digital signal.
Step 820: Is the operation of the data generator 505 finished? If the operation of the data generator 505 is finished, go to Step 825; otherwise, go to Step 805 and operate the data generator 505 to generate a next digital test signal.
Step 825: The receiving unit 515 receives the total digital signals Sₜ₁″˜Sₜₙ″ generated by the ADC 510 and draws the practical conversion curve C₁ according to the received digital signals Sₜ₁″˜Sₜₙ″ and the digital test signals Sₜ₁˜Sₜₙ.
Step 830: End.

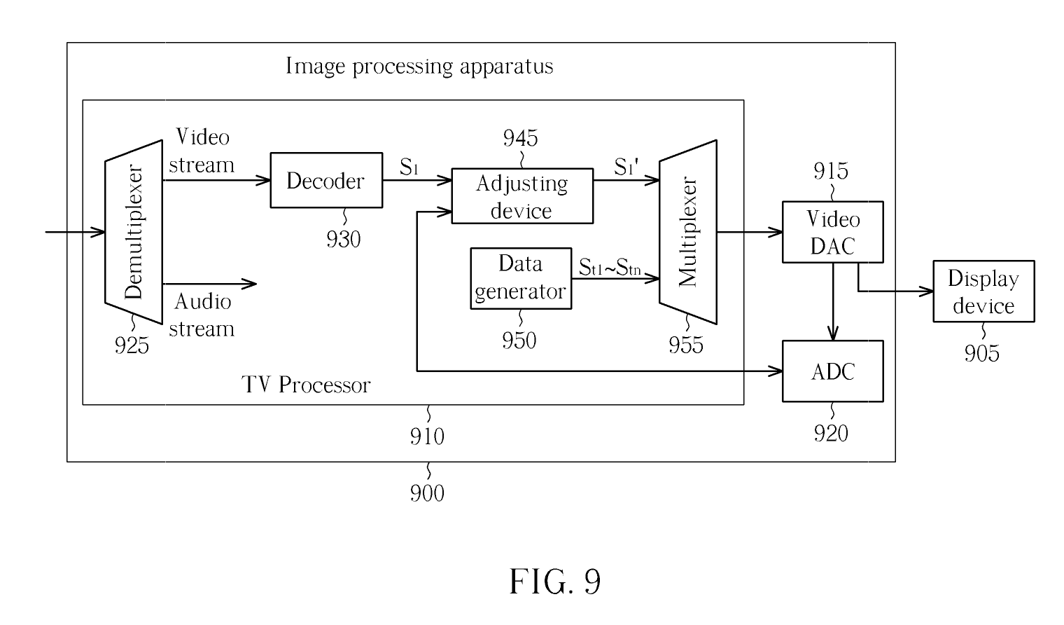

In another embodiment, by dynamically calculating the DAC calibration mapping table 305, the target mapping table 310 can also be established dynamically instead of being established in advance. For instance, the target mapping table 310 can be established when/after the TV system 100 is powered up. An advantage of establishing the target mapping table 310 by dynamically calculating the DAC calibration mapping table 305 is illustrated as follows: the TV system 100 instantaneously calculates input values and output values of entries in the DAC calibration mapping table 305 when/after the TV system 100 is started, to avoid the degree of nonlinearity of the video DAC 125 being altered due to temperature changes or other factors. Please refer to FIG. 9. FIG. 9 is a simplified diagram of an image processing apparatus 900 according to a second embodiment of the present invention. Please note that, in the second embodiment, the operation and function of the image processing apparatus 117 is replaced by that of the image processing apparatus 900, yet other elements (i.e. the antenna 105, tuner 110, demodulator 115, and the display device 130) function as well as the description of the first embodiment. As shown in FIG. 9, the image processing apparatus 900 is coupled to a display device 905 and utilized for receiving a baseband signal outputted from the demodulator 115 to generate an output analog image signal to the display device 130. The image processing apparatus 900 comprises a TV processor 910, a video DAC 915, and an ADC 920. The TV processor 910 comprises a demultiplexer 925, a decoder 930, an adjusting device 945, a data generator 950, and a multiplexer 955. The operation and function of the display device 905, video DAC 915, ADC 920, demultiplexer 925, decoder 930, and the data generator 950 are similar to those of the display device 130, video DAC 125, ADC 510, demultiplexer 135, decoder 140, and the data generator 505 in the above-mentioned description; further description is therefore not detailed here for brevity. When/after the TV system is powered up, the data generator 950 generates multiple digital test signals Sₜ₁˜Sₜₙ to the multiplexer 955, and the TV processor 910 controls the multiplexer 955 to transmit the digital test signals Sₜ₁˜Sₜₙ to the video DAC 915. The video DAC 915 then converts the digital test signals Sₜ₁˜Sₜₙ into analog test signals Sₜ₁′˜Sₜₙ′ and outputs the analog test signals Sₜ₁′˜Sₜₙ′ to the ADC 920. The ADC 920 converts the analog test signals Sₜ₁′˜Sₜₙ′ into digital signals Sₜ₁″˜Sₜₙ″ and transmits the digital signals Sₜ₁″˜Sₜₙ″ to the adjusting device 945. The adjusting device 945 is utilized for calculating a DAC calibration mapping table, combining a gamma correction mapping table and the DAC calibration mapping table to generate a target mapping table used for converting a raw digital image signal S₁ into a calibrated digital image signal S₁′, and for storing the target mapping table into a storage device (e.g. a memory, not shown in FIG. 9) coupled to the adjusting device 945. Accordingly, the adjusting device 945 can dynamically build the target mapping table according to the gamma correction mapping table and DAC calibration mapping table calculated by referring to the digital test signals Sₜ₁˜Sₜₙ and the digital signals Sₜ₁″˜Sₜₙ″.

Please note that, in the second embodiment, the scheme of calculating the DAC calibration mapping table by referring to the digital test signals Sₜ₁˜Sₜₙ and the digital signals Sₜ₁″˜Sₜₙ″ is identical to that of calculating the DAC calibration mapping table 305 of FIG. 3, and the establishment of the target mapping table by combining the gamma correction mapping table and the DAC calibration mapping table is also similar to that of the target mapping table 310 of FIG. 3; further description is not detailed. Additionally, if the storage device is only utilized for storing information used for performing the gamma correction and DAC calibration (i.e. the target mapping table), a size of the storage device can be substantially equal to a maximum between sizes of the gamma correction mapping table and DAC calibration mapping table. In other words, if the gamma correction mapping table is stored in the storage device first, the target mapping table can be stored into the storage device even though part of the entries of the gamma correction mapping table may be overwritten (since the gamma correction mapping table is not required after the target mapping table is generated by combining the gamma correction mapping table and DAC calibration mapping table).

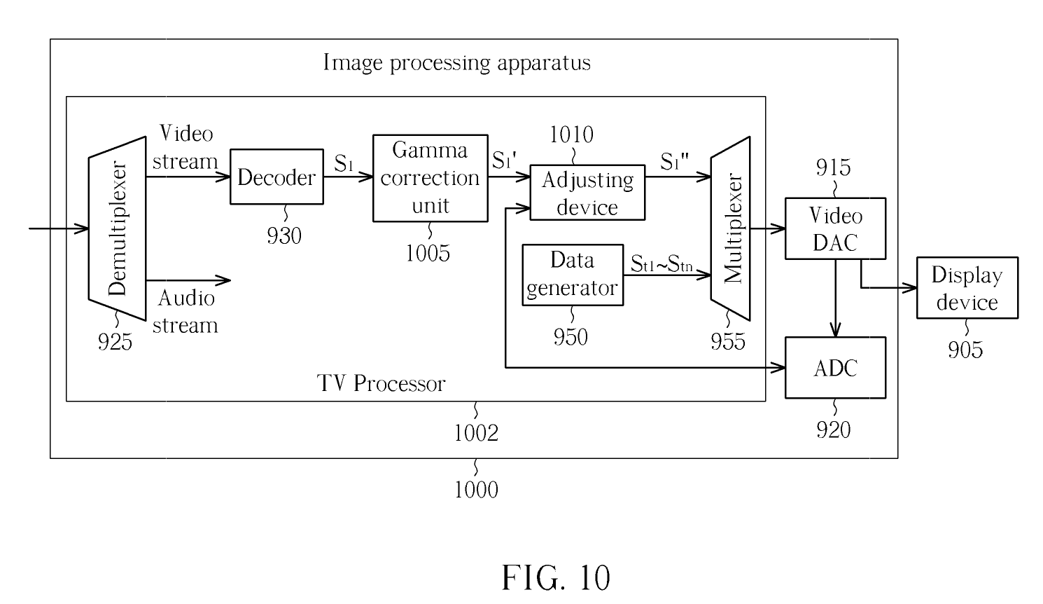

Furthermore, in another embodiment, if the size of the above-mentioned storage device is not considered (i.e. the storage capacity of the storage device is large enough for storing the gamma correction mapping table and DAC calibration mapping table), the gamma correction mapping table and DAC calibration mapping table can be directly utilized for respectively adjusting the above-mentioned raw digital image signal, without combining the two mapping tables to generate the target mapping table. That is, the gamma correction and the DAC calibration are performed separately in this embodiment. Please refer to FIG. 10. FIG. 10 is a simplified diagram of an image processing apparatus 1000 according to a third embodiment of the present invention. A major difference between the image processing apparatuses 900 and 1000 is described in the following. In the image processing apparatus 1000, a gamma correction unit 1005 performs the gamma correction on a raw digital image signal S₁ to generate an adjusted digital image signal S₁′ according to a gamma correction mapping table, and an adjusting unit 1010 adjusts the adjusted digital image signal S₁′ to generate a calibrated digital image signal S₁″ according to a DAC calibration mapping table. In this embodiment, the adjusting unit 1010 also dynamically builds the DAC calibration mapping table by utilizing a method identical to how the adjusting device 945 builds the DAC calibration mapping table; further description is not detailed. It should be noted that, in other embodiments, the DAC calibration can also be performed before the gamma correction. In other words, the gamma correction unit 1005 can be changed to be disposed directly after the adjusting unit 1010 so that the adjusting unit 1010 adjusts the raw digital image signal S₁ to generate a calibrated digital image signal S₂ according to the DAC calibration mapping table and the gamma correction unit 1005 and performs the gamma correction on the calibrated digital image signal S₂ to generate an adjusted digital image signal S₂′ into the multiplexer 955 according to the gamma correction mapping table. This also obeys the spirit of the present invention.

In summary, the disclosed embodiments of the present invention provide apparatus and related methods for solving the problems caused by the nonlinearity of a DAC (e.g. a video DAC of a TV system utilized for outputting output analog image signals to a display device). Some apparatus further save a part of areas of total circuits by combining the gamma correction mapping table and DAC calibration mapping table to generate the target mapping table and by only storing the target mapping table in a storage device, without storing both the gamma correction mapping table and DAC calibration mapping table in the storage device.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for building a target mapping table utilized for converting a raw digital image signal into a calibrated digital image signal, the method comprising:
storing a color look-up table;
calculating a digital-to-analog converter (DAC) calibration mapping table; and
combining the color look-up table and the DAC calibration mapping table to generate the target mapping table.

2. The method of claim 1, wherein the color look-up table includes a plurality of entries each mapping an input value to an output value, the DAC calibration mapping table includes a plurality of entries each mapping an input value to an output value, and the step of combining the color look-up table and the DAC calibration mapping table comprises:
if a first entry in the color look-up table maps a first input value to a first output value, and a second entry in the DAC calibration mapping table maps a second input value to a second output value where the second input value is equal to the first output value, recording an entry of the target mapping table to map the first input value to the second output value.

3. The method of claim 1, wherein the color look-up table includes a plurality of entries each mapping an input value to an output value, the DAC calibration mapping table includes a plurality of entries each mapping an input value to an output value, and the step of combining the color look-up table and the DAC calibration mapping table comprises:
if a first entry in the DAC calibration mapping table maps a first input value to a first output value, and a second entry in the color look-up table maps a second input value to a second output value where the second input value is equal to the first output value, recording an entry of the target mapping table to map the first input value to the second output value.

4. An image processing apparatus, comprising:
a storage device, storing a color look-up table;
an adjusting device, coupled to the storage device, for calculating a digital-to-analog converter (DAC) calibration mapping table, combining the color look-up table and the DAC calibration mapping table to generate a target mapping table utilized for converting a raw digital image signal into a calibrated digital image signal, and storing the target mapping table into the storage device.

5. The image processing apparatus of claim 4, wherein the color look-up table includes a plurality of entries each mapping an input value to an output value; the DAC calibration mapping table includes a plurality of entries each mapping an input value to an output value; and the adjusting device records an entry of the target mapping table to map a first input value to a second output value when a first entry in the color look-up table maps the first input value to a first output value and a second entry in the DAC calibration mapping table maps a second input value to the second output value where the second input value is equal to the first output value.

6. The image processing apparatus of claim 4, wherein the color look-up table includes a plurality of entries each mapping an input value to an output value; the DAC calibration mapping table includes a plurality of entries each mapping an input value to an output value; and the adjusting device records an entry of the target mapping table to map a first input value to a second output value if a first entry in the DAC calibration mapping table maps the first input value to a first output value and a second entry in the color look-up table maps a second input value to the second output value where the second input value is equal to the first output value.

7. The image processing apparatus of claim 4, wherein a size of the storage device is substantially equal to a maximum between a size of the color look-up table and a size of the DAC calibration mapping table.

8. An image processing apparatus for outputting an output analog image signal according to a raw digital image signal, comprising:
a video DAC;
a storage device, for storing a target mapping table equivalent to a combination of a color look-up table and a DAC calibration mapping table corresponding to the video DAC; and
an adjusting device, coupled to the video DAC and the storage device, for adjusting the raw digital image signal to generate a calibrated digital image signal according to the target mapping table stored in the storage device;
wherein the video DAC converts the calibrated digital image signal to generate the output analog image signal.

9. The image processing apparatus of claim 8, wherein a size of the storage device is substantially equal to a maximum between a size of the color look-up table and a size of the DAC calibration mapping table.

10. A signal processing apparatus for generating an output analog signal according to a raw digital signal, comprising:
a DAC;
a storage device, for storing a target mapping table equivalent to a combination of a predetermined look-up table and a DAC calibration mapping table corresponding to the DAC; and
an adjusting device, coupled to the DAC and the storage device, for adjusting the raw digital signal to generate a calibrated digital signal according to the target mapping table stored in the storage device;
wherein the DAC converts the calibrated digital signal to generate the output analog signal.

11. The signal processing apparatus of claim 10, wherein a size of the storage device is substantially equal to a maximum between a size of the predetermined look-up table and a size of the DAC calibration mapping table.
